(19) United States
(12) Patent Application Publication
(10) Pub. No.: US 2019/0337251 A1
(43) Pub. Date: Nov. 7, 2019

(54) BEAD SETTING ASSEMBLY

(71) Applicant: The Goodyear Tire & Rubber Company, Akron, OH (US)

(72) Inventors: Dennis Alan Lundell, Akron, OH (US); Steven John Chesnes, Wickliffe, OH (US); William Dudley Currie, Stow, OH (US); John Edward Anderson, Atwater, OH (US)

(21) Appl. No.: 16/511,100

(22) Filed: Jul. 15, 2019

Related U.S. Application Data
(62) Division of application No. 15/172,445, filed on Jun. 3, 2016.

(51) Int. Cl. B29D 30/32

(52) U.S. Cl. CPC B29D 30/32; B29D 2030/3207

(57) ABSTRACT

An improved bead setting assembly includes at least one bead setter. The bead setter in turn includes a frame member and magnetic segments pivotally mounted on the frame member at positions about an opening in the frame member. Means are provided to selectively rotate the magnetic segments radially inwardly to a bead retaining position and radially outwardly from the bead retaining position. A plurality of clamp segments are pivotally mounted on the frame member at positions about the frame opening, and each clamp segment in turn includes a clamp arm with a multi-piece construction. Means are provided for selectively rotating the clamp segments radially inwardly into engagement with the bead and radially outwardly from the bead engagement. A rotary encoder is mounted on the frame member and is operatively connected to a selected one of the clamp segments for determining a disposition of the bead.

### FIELD OF THE INVENTION

The invention relates to pneumatic tires, and more particularly, to equipment for the precise positioning of tire beads during the manufacture of tires. Specifically, the invention is directed to an improved bead setting assembly that desirably detects the diameter of the tire bead, monitors the disposition of the tire bead and reduces potential damage to the bead setting assembly in the event of a disengaged or improperly positioned bead.

### BACKGROUND OF THE INVENTION

A bead is the part of a tire that includes an annular tensile member wrapped by ply cords and shaped to fit the wheel rim. Typically, a bead is integrated into each side of the tire to provide a secure fit of the tire on each side of the wheel rim. As a result, most tires include an inboard bead and an outboard bead.

In the manufacture of a tire, the tire is typically built or assembled on a tire-building machine, which includes a drum. A tire innerliner is wrapped about the drum and one or more plies are wrapped on the innerliner. The inboard and outboard beads are then positioned about the drum, and the area of the drum under the bead is expanded by pneumatic and/or mechanical means, as known to those skilled in the art, to engage the bead. A bladder on the drum is inflated to turn up the plies from the outward sides of the drum to cover the beads, and the sidewalls are pressed onto both sides.

As is known in the art, another machine is used to then apply the belts, cap and tread to form what is known as a green tire. The green tire is inserted into a mold or press for forming of the tread pattern and curing.

For the positioning of the beads about the drum, a mechanism referred to in the art as a bead setting assembly is employed. A bead setting assembly receives each bead and retains the beads adjacent the drum of the tire building machine. The bead setting assembly then moves over the drum, or the drum moves inside of the bead setting assembly, for final positioning of the inboard and outboard beads about the drum before the area of the drum under the bead is expanded.

While prior art bead setting assemblies have been satisfactory for the purpose of positioning the beads adjacent the drum, they include certain disadvantages. For example, for complex tire building machines that produce different sizes of tires, beads of differing diameters are required in what may be a fairly rapid sequence. Prior art bead setting assemblies typically retain and position a specific bead, but cannot detect the diameter of the bead to determine if the proper bead size is being employed. Therefore, when different size tires are being produced, the prior art bead setting assemblies cannot confirm conformance of the bead diameter to the specific tire that is to be made. It is also desirable for a bead setting assembly to determine whether the bead is within a specific tolerance range for improved quality control.

In addition, the prior art bead setting assemblies have been unable to detect when a bead becomes disengaged from the bead setting assembly or is out of position after initial engagement with the bead and prior to proper positioning of the bead about the drum. It is desirable to detect disengagement or improper positioning after initial engagement with the bead, so that the tire building process may be halted for automatic or manual repositioning of the bead. Finally, certain designs for the prior art bead setting assemblies have employed mechanical arms that apply a radially inward force to retain the position of the bead. The arms thus extend radially inwardly until the positive mechanical engagement with the bead halts their extension. In the event of the bead becoming disengaged or out of position, the arms may extend radially inwardly far enough to contact the drum, which may undesirably damage the arms.

Therefore, it is desirable to provide an improved bead setting assembly that desirably detects the diameter of the tire bead, optionally determines whether the bead is within a specific tolerance range, monitors the disposition of the tire bead to detect disengagement or improper positioning of the bead, and includes a structure that reduces potential damage to the bead setting assembly in the event of a disengaged or improperly positioned bead.

### SUMMARY OF THE INVENTION

According to an aspect of an exemplary embodiment of the invention, an improved bead setting assembly includes at least one bead setter. The at least one bead setter includes an annular frame member and a plurality of magnetic segments pivotally mounted on the frame member at spaced-apart positions about an opening formed in the annular frame member. Each of the magnetic segments includes a bead retaining surface. Means are provided to selectively rotate the magnetic segments radially inwardly to a bead retaining position and radially outwardly from the bead retaining position. A plurality of clamp segments are pivotally mounted on the frame member at spaced-apart positions about the opening formed in the annular frame member. Means are provided for selectively rotating the clamp segments radially inwardly into engagement with the bead and radially outwardly from the bead engagement. A rotary encoder is mounted on the frame member and is operatively connected to a selected one of the clamp segments for determining a disposition of a bead.

In another aspect of an exemplary embodiment of the invention, an improved bead setting assembly includes at least one bead setter. The at least one bead setter includes an annular frame member and a plurality of magnetic segments pivotally mounted on the frame member at spaced-apart positions about an opening formed in the annular frame member. Each of the magnetic segments includes a bead retaining surface. Means are provided to selectively rotate the magnetic segments radially inwardly to a bead retaining position and radially outwardly from the bead retaining position. A plurality of clamp segments are pivotally mounted on the frame member at spaced-apart positions about the opening formed in the annular frame member and each clamp segment includes a clamp arm that in turn includes a multi-piece construction. Means are provided for selectively rotating the clamp segments radially inwardly into engagement with the bead and radially outwardly from the bead engagement.

### BRIEF DESCRIPTION OF DRAWINGS

The invention will be described by way of example and with reference to the accompanying drawings, in which:

FIG. 1 is a perspective view of an exemplary embodiment of the improved bead setting assembly of the invention;

FIG. 2 is a perspective view of the inboard side of the inboard bead setter shown in FIG. 1;

FIG. 3 is an elevational view of the inboard side of the inboard bead setter shown in FIG. 1;

FIG. 4 is a perspective view of the outboard side of the inboard bead setter shown in FIG. 1;

FIG. 5 is an enlarged fragmentary perspective view of a portion of the inboard side of the inboard bead setter shown in FIG. 1;

FIG. 6 is a perspective view of an arm of the outboard bead setter shown in FIG. 1 in a straight position;

FIG. 7 is a perspective view of an arm of the inboard bead setter shown in FIG. 1 in a straight position;

FIG. 8 is a perspective view of the arm shown in FIG. 6 in a bent position; and

FIG. 9 is a perspective view of the arm shown in FIG. 7 in a bent position.

Similar numerals refer to similar parts throughout the drawings.

### DETAILED DESCRIPTION OF THE INVENTION

It is to be understood that the term inboard is referred to herein as a direction corresponding to the axially inner surface or side of a tire, and the term outboard is referred to herein as a direction corresponding to the axially outer surface or side of a tire. The term axially inwardly refers to an axial direction that is toward the center plane of a tire, and the term axially outwardly refers to an axial direction that is away from the center plane of a tire. The term radially inwardly refers to a radial direction that is toward the central axis of rotation of a tire, and the term radially outwardly refers to a radial direction that is away from the central axis of rotation of a tire.

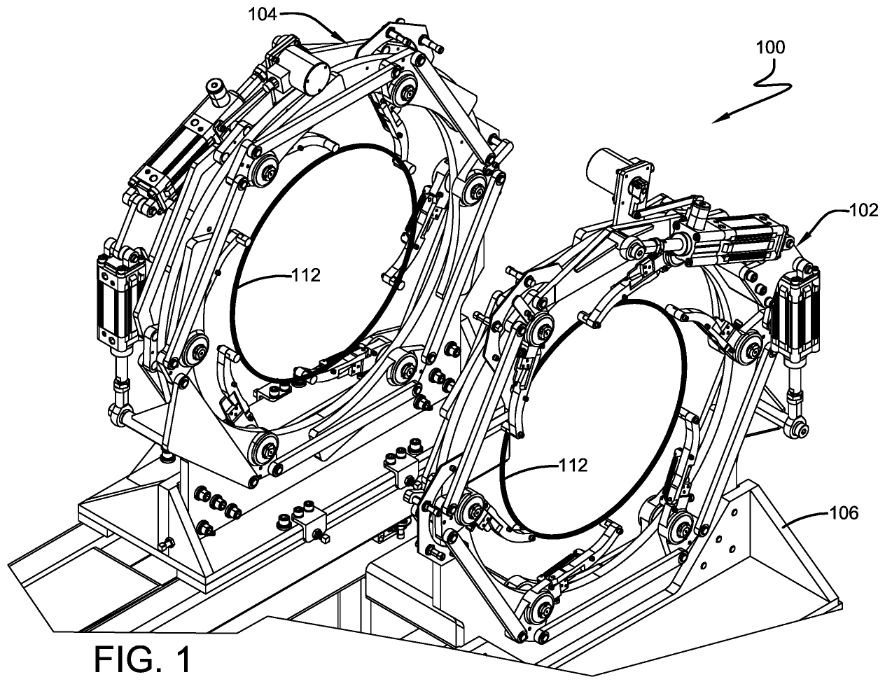

An exemplary embodiment of an improved bead setting assembly of the present invention is indicated generally at 100, and is shown in FIG. 1. The bead setting assembly includes an inboard bead setter 102 and an outboard bead setter 104, which are mounted on a frame 106. Inasmuch as the inboard and outboard bead setters 102, 104, are similar in structure and function to one another, only the inboard bead setter will be described below for the purpose of convenience.

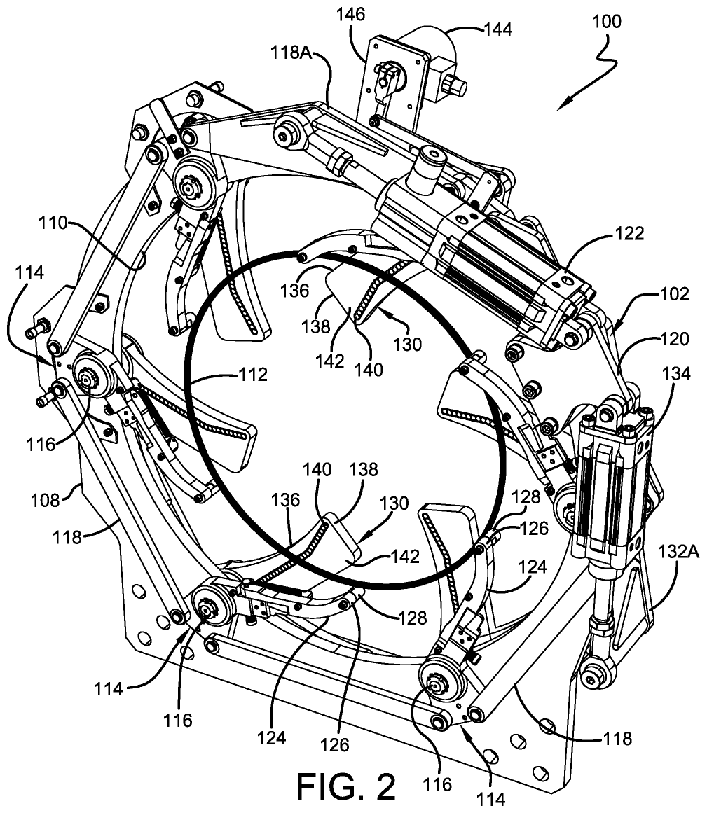

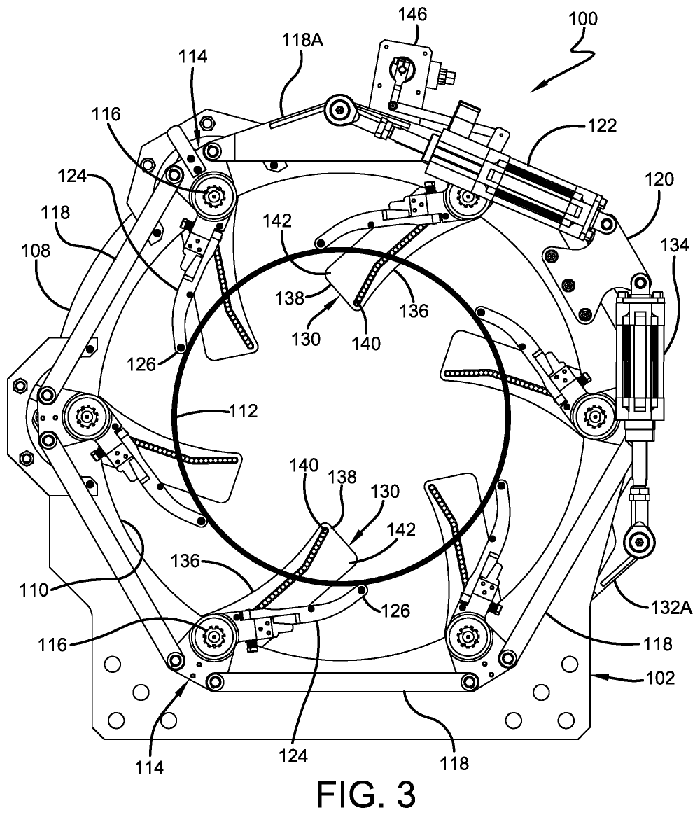

With additional reference to FIGS. 2 through 4, the bead setter 102 includes an annular frame member 108 formed with a circular opening 110. A plurality of clamp segments 114 are spaced about the annular frame member 108 and are pivotally mounted on the annular frame member by respective pivot connections 116. The clamp segments 114 are connected to one another by clamp links 118, which are pivotally connected to the clamp segments at positions radially outward of the respective pivot connections 116.

A yoke 120 is mounted on the annular frame member 108, and supports a clamp segment piston and cylinder assembly 122. The clamp segment piston and cylinder assembly 122 is operably connected to a selected one of the clamp links 118A and actuates circumferential movement of the selected clamp link. Because the clamp links 118 interconnect the clamp segments 114, actuation of the selected clamp link 118A by the clamp segment piston and cylinder assembly 122 moves the clamp links circumferentially and rotates the clamp segments. Each clamp segment 114 includes a clamp arm 124 that extends from its respective pivot connection 116 to a radially inward end 126. A bead engaging pin 128 is mounted on the radially inward end 126 of each clamp arm 124 and extends axially inwardly from its respective clamp arm.

For initial placement of an annular bead 112 in the bead setter 102, a plurality of magnetic segments 130 are spaced about the annular frame member 108 and pivotally mounted on the opposite side of the annular frame member from the clamp segments 114 by the respective pivot connections 116. The magnetic segments 130 are connected to one another by magnetic segment links 132, which are pivotally connected to the magnetic segments at positions radially outward of the respective pivot connections 116.

A magnetic segment piston and cylinder assembly 134 is mounted on the yoke 120. The magnetic segment piston and cylinder assembly 134 is operably connected to a selected one of the magnetic segment links 132A and actuates circumferential movement of the selected magnetic segment link. Because the magnetic segment links 132 interconnect the magnetic segments 130, actuation of the selected magnetic segment link 132A by the magnetic segment piston and cylinder assembly 134 moves the magnetic segment links circumferentially and rotates the magnetic segments. Each magnetic segment 130 includes a magnetic arm 136 that extends from its respective pivot connection 116 to a radially inward end 138. Permanent magnets 140 preferably are set into and attached or adhered to an axially inward surface 142 of each magnetic arm 136 between the pivot connection 116 and the radially inward end 138 of the magnetic arm.

In operation, the magnetic segment piston and cylinder assembly 134 is actuated, which causes the magnetic arms 136 to rotate to a radially inward position. The annular bead 112, which includes ferrous material, is placed against the axially inward surface 142 of each magnetic arm 136 manually by an operator, or automatically by additional machinery (not shown), and the magnets 140 retain the bead perpendicular to the central axis of the bead setter 102. The clamp segment piston and cylinder assembly 122 is actuated, which causes the clamp arms 124 to rotate to a radially inward position, which brings the bead pin 128 of each respective arm into engagement with the outer periphery of the bead 112, and centers the bead about the central axis of the bead setter 102.

The magnetic segment piston and cylinder assembly 134 is then actuated in an opposite direction, which causes the magnetic arms 136 to rotate to a radially outward position and thus retract. The bead 112 slides off of the magnets 140 and is supported evenly and concentrically on the bead pins 128 of the clamp arms 124.

In this condition, the bead setting assembly 100 is then moved axially over the drum of a tire building machine (not shown), or a drum is moved axially into the bead setting assembly to a predetermined position. The drum supports a tire casing, which is expanded into engagement with the bead 112. When the tire casing engages the bead 112, the clamp segment piston and cylinder assembly 122 is actuated in an opposite direction, which causes the clamp arms 124 to rotate to a radially outward position and thus retract. After the clamp arms 124 have retracted, the bead setting assembly 100 is moved axially back from the drum of the tire building machine, or the drum is moved axially back from the bead setting assembly.

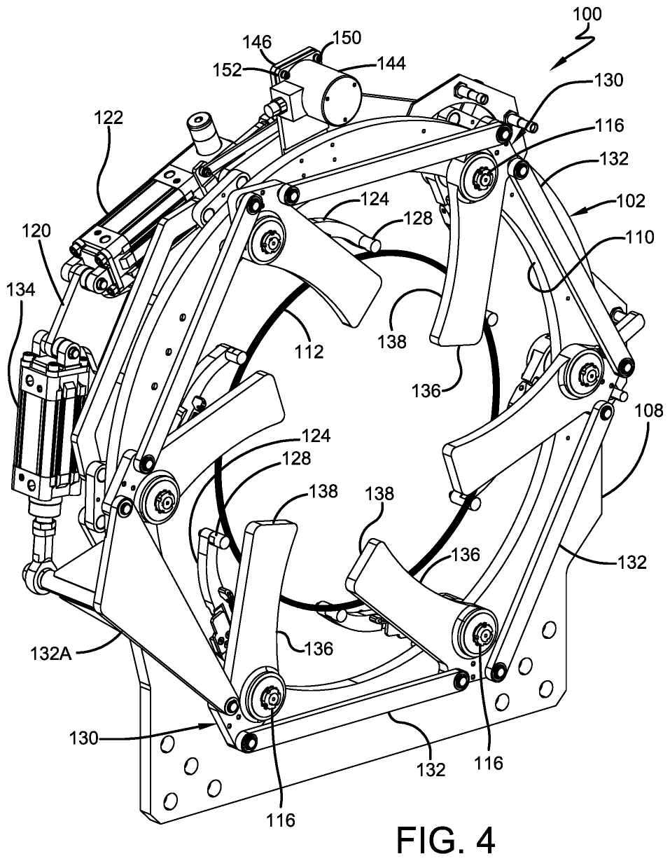

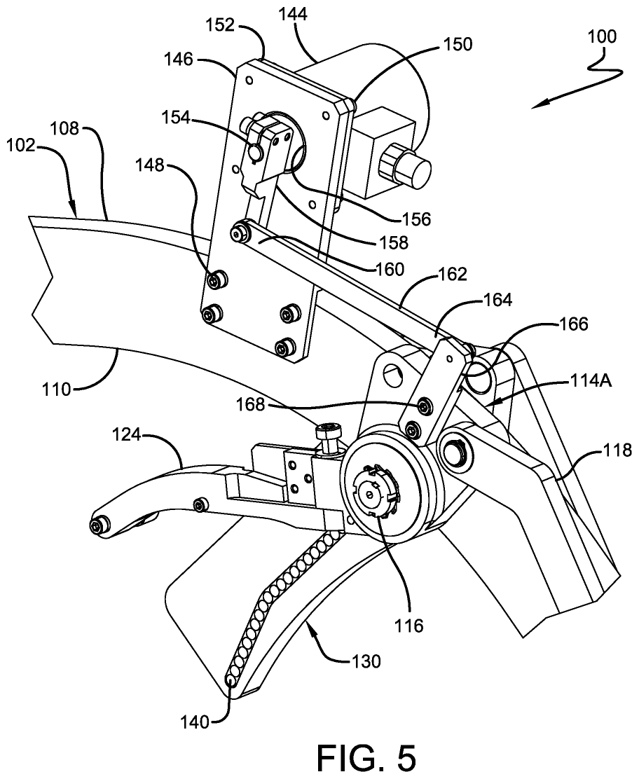

With particular reference to FIG. 5, the bead setting assembly 100 of the present invention includes an encoder 144, which preferably is a rotary encoder. The rotary encoder 144 is operatively connected to a selected one of the clamp segments 114A. For example, a bracket 146 is rigidly attached to the bead setter frame member 108 by means such as mechanical fasteners 148. With reference to FIGS. 4 and 5, the rotary encoder 144 is secured to the bracket 146 by means such as an adapter plate 152 and mechanical fasteners 150. A shaft 154 of the rotary encoder 144 passes through an opening 156 formed in the bracket 146 and engages a first crank arm 158. The first crank arm 158 in turn is pivotally attached to a first end 160 of an encoder link 162. A second end 164 of the encoder link 162 is pivotally attached to a second crank arm 166, which in turn is rigidly attached to the selected clamp segment 114A by means such as mechanical fasteners 168.

When the clamp segment piston and cylinder assembly 122 actuates and rotates the clamp segments 114 as described above, the rotational motion of the selected clamp segment 114A is translated by the pivotal connection of the second crank arm 166 to the encoder link 162, and by the pivotal connection of the encoder link to the first crank arm 158, to the rotary encoder 144. In this manner, the rotary encoder 144 senses the distance that the selected clamp segment 114A has rotated. Because the rotation of the selected clamp segment 114A dictates the radial position of the clamp arm 124 and thus the bead pin 128 (FIG. 2), the distance that the selected clamp segment rotates corresponds to the distance that the clamp arm extends radially inwardly.

As will be understood from the description above, the clamp arm 124 extends radially inwardly for a specific distance for a respective bead 112. Therefore, when beads 112 of different diameters are handled by the bead setting assembly 100, the clamp arm 124 will travel radially inwardly a predetermined distance for each respective bead. The rotary encoder 144, by measuring the amount of rotation of the selected clamp segment 114A, thus measures the distance that the clamp arm 124 has extended radially inwardly, and correlates that distance to the particular bead 112 that is being handled by the bead setting assembly 100.

A control system (not shown) that is operatively connected to the rotary encoder 144 monitors the readings from the encoder for unplanned changes in the distance that the clamp arm 124 has extended radially inwardly, which indicates an improper disposition, such as an improper change in the diameter of the bead 112. Such an improper change in the diameter of the bead 112 may be a dropped bead, a jammed bead, or a bead of improper diameter. Due to the monitoring of the rotary encoder 144 by the control system, the system can then activate an alert for an operator, who can intervene accordingly.

Preferably, the rotary encoder 144 includes a sensitivity level of approximately forty (40) counts per millimeter of bead diameter, which is sufficient to confirm the proper diameter of the bead 112. The rotary encoder 144 may also be of sufficient sensitivity to accurately check the tolerance of the diameter of the bead 112 to ensure that the bead diameter is within an acceptable tolerance range. For example, the encoder link 162 and crank arms 158, 166 preferably are sufficiently within a linear tolerance to be within a two (2) millimeter diameter bead-size reading.

With this structure, the rotary encoder 144 thus enables the bead setting assembly 100 to accurately measure the diameter of the bead 112 to confirm the proper bead size is being applied to the tire, which is an important function on a tire building machine that produces different size tires simultaneously. In addition, optional constant monitoring of the diameter of the bead 112 by the rotary encoder 144 enables the bead setting assembly to detect a dropped or jammed bead at any time between initial pickup of the bead and the final location of the bead on the tire building drum.

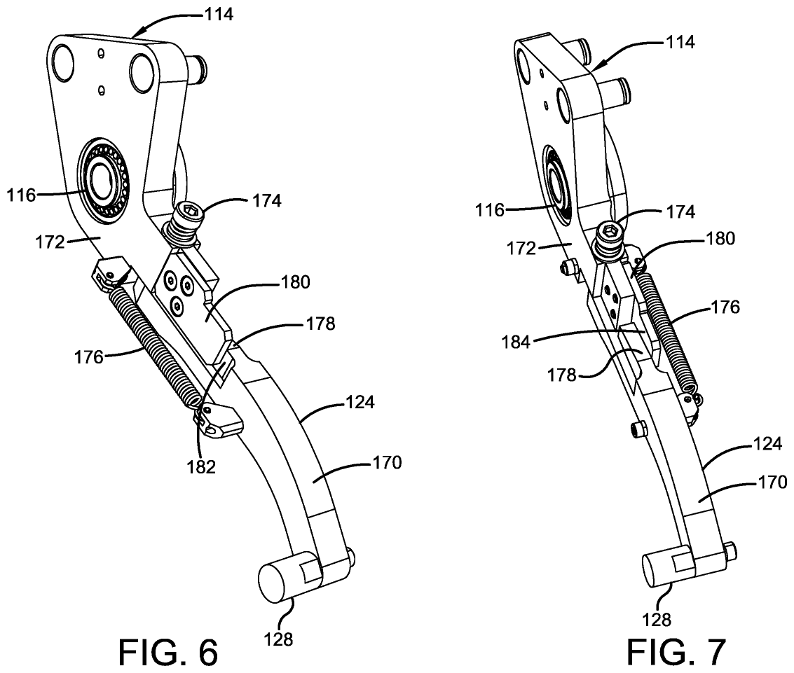

Turning now to FIGS. 6 through 9, the bead setting assembly 100 of the present invention also includes clamp segments 114 with clamp arms 124 of a multi-piece construction. More particularly, each respective clamp arm 124 includes multiple components that enable each arm to deflect. For example, the clamp arm 124 includes a radially inward piece 170 and a radially outward piece 172. The bead engaging pin 128 is mounted on the radially inward piece 170 and the radially outward piece 172 is adjacent the pivot connection 116 of the clamp segment 114. The radially inward piece 170 and the radially outward piece 172 are pivotally connected to one another by a pin 174. Preferably, the 174 pin is a spring-loaded mechanical fastener, such as a screw, which provides a secure connection between the inward piece 170 and the outward piece 172 and may optionally enable the adjustment of the tension between the inward and outward pieces.

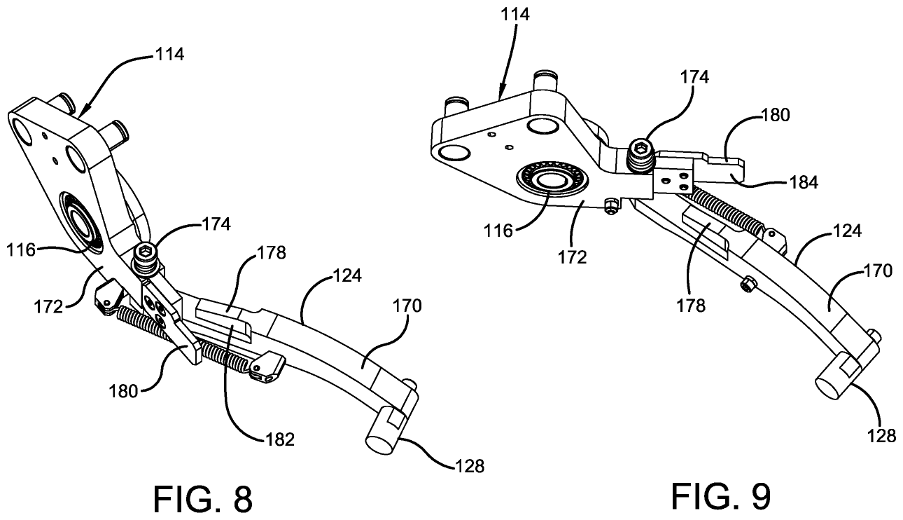

As shown in FIGS. 8 and 9, if the clamp arm 124 contacts the drum of a tire building machine, in order to minimize potential damage to the bead setting assembly 100, the inward piece 170 deflects by rotating about the pin 174 up to about forty-five (45) degrees relative to the outward piece 172. If the bead setting assembly 100 is configured to move axially over the drum of a tire building machine, the deflection of the inward piece 170 is in a direction opposite the axial movement of the bead setting assembly over the drum. If the bead setting assembly 100 is configured so that the drum of the tire building machine moves axially into the bead setting assembly, the deflection of the inward piece 170 is in the same direction as the axial movement of the drum. Optionally, the bead setting assembly 100 may be equipped with means to sense that such deflection has occurred, such as a proximity sensor, to inform a control system and/or an operator of the deflection.

In order to enable the inward piece 170 and the outward piece 172 to align with one another after deflection has occurred, a resilient member such as a spring 176 extends between the inward and outward pieces. In addition, the inward member 170 includes a radially-outwardly extending extension 178 and the outward member 172 includes a radially-inwardly extending extension 180. The radially-outwardly extension 178 and the radially-inwardly extension 180 overlap with one another and include respective mechanical stop surfaces 182 and 184. Thus, after a deflection of the clamp arm 124 has occurred, the resilient member 176 is biased to return the inward member 170 back into alignment with the outward member. Once that alignment has been reached, the mechanical stop surface 182 of the inward member 170 engages the mechanical stop surface 184 of the outward member, thereby maintaining the alignment of the inward member with the outward member.

With this structure, each clamp arm 124 of the bead setting assembly includes a two-piece, spring-loaded construction. In the event that the bead 112 is dropped or jams on a protruding part of the tire (not shown) as the bead is being placed over the drum of the tire building machine, this construction of the clamp arms 124 enables the arms to deflect if they contact the drum. By enabling the clamp arms 124 to deflect, the potential for damage to the bead setting assembly 100 is reduced.

In this manner, the improved bead setting assembly 100 of the present invention provides a structure that detects the diameter of the tire bead, and optionally determines whether the bead is within a specific tolerance range. The improved bead setting assembly 100 of the present invention also includes optional continuous monitoring of the disposition of the tire bead to detect disengagement or improper positioning of the bead. Moreover, the improved bead setting assembly 100 of the present invention includes two-piece, spring-loaded clamp arms 124 that reduce potential damage to the bead setting assembly in the event of a disengaged or improperly positioned bead.

The present invention also includes a method of forming a tire using an improved bead setting assembly. The method includes steps in accordance with the description that is presented above and shown in FIGS. 1 through 9.

It is to be understood that the structure of the above-described improved bead setting assembly 100 may be altered or rearranged, or components known to those skilled in the art omitted or added, without affecting the overall concept or operation of the invention.

The invention has been described with reference to a preferred embodiment. Potential modifications and alterations will occur to others upon a reading and understanding of this description. It is to be understood that all such modifications and alterations are included in the scope of the invention as set forth in the appended claims, or the equivalents thereof.

What is claimed is:

1. A bead setting assembly, the assembly including at least one bead setter, the at least one bead setter comprising:
an annular frame member;
a plurality of magnetic segments pivotally mounted on the frame member at spaced-apart positions about an opening formed in the annular frame member, each of the magnetic segments including a bead retaining surface;
means for selectively rotating the magnetic segments radially inwardly to a bead retaining position and radially outwardly from the bead retaining position;
a plurality of clamp segments pivotally mounted on the frame member at spaced-apart positions about the opening formed in the annular frame member, wherein each clamp segment includes a clamp arm comprising a multi-piece construction;
means for selectively rotating the clamp segments radially inwardly into engagement with the bead and radially outwardly from the bead engagement; and
a rotary encoder mounted on the frame member and being operatively connected to a selected one of the clamp segments for determining a disposition of a bead.

2. The bead setting assembly of claim 1, wherein the rotary encoder is attached to a bracket that is rigidly attached to the frame member.

3. The bead setting assembly of claim 1, wherein:
a first crank arm engages a shaft of the rotary encoder;
an encoder link is pivotally attached to the first crank arm; and
a second crank arm is pivotally attached to the encoder link, wherein the second crank arm is rigidly attached to the selected clamp segment.

4. The bead setting assembly of claim 1, wherein the rotary encoder senses the radial extension distance traveled by a clamp arm of the selected clamp segment.

5. The bead setting assembly of claim 1, wherein the rotary encoder is operatively connected to a control system for selectively activating an alert.

6. The bead setting assembly of claim 1, wherein the rotary encoder includes a sensitivity level of approximately forty counts per millimeter of bead diameter.

7. The bead setting assembly of claim 1, wherein each clamp arm includes a radially inward piece and a radially outward piece, the radially inward and outward pieces being pivotally connected to one another by a pin.

8. The bead setting assembly of claim 13, wherein the pin is a spring-loaded mechanical fastener.

9. The bead setting assembly of claim 13, wherein the inward piece is capable of rotating about the pin up to about forty-five degrees relative to the outward piece.

10. The bead setting assembly of claim 13, further comprising a resilient member extending between and connecting the inward and outward pieces.

11. The bead setting assembly of claim 13, wherein the inward member includes a radially-outwardly extending extension being formed with a respective mechanical stop surface and the outward member includes a radially-inwardly extending extension being formed with a respective mechanical stop surface, the mechanical stop surfaces cooperating to enable alignment of the inward and outward members.
